(19) United States
(12) Patent Application Publication
(10) Pub. No.: US 2009/0158961 A1
(43) Pub. Date: Jun. 25, 2009

(54) Wood preservative compositions

(75) Inventors: Jun Zhang, Gertzville, NY (US); Robert D. Inwards, North Tonawanda, NY (US)

Correspondence Address: MILBANK, TWEED, HADLEY & MCCLOY LLP, INTERNATIONAL SQUARE BUILDING, 1850 K STRET, N.W., SUITE 1100, WASHINGTON, DC, 20006, US

(73) Assignee: Osmose, Inc.

(21) Appl. No.: 12/073,452

(22) Filed: Mar. 5, 2008

Related U.S. Application Data
(60) Provisional application No. 61/008,557, filed on Dec. 21, 2007.

(51) Int. Cl. C09D 5/14

(52) U.S. Cl. 106/18

(57) ABSTRACT

The present invention provides a wood preservative composition and a process for treating wood with the composition for protecting wood from decay and insect attack. The invention further provides a wood preservative composition comprising dispersed particles of a copper compound and a polydentate ligand. The composition can be used to treat difficult-to-treat wood species including hem fir, Douglas-fir, ponderosa pine, red pine, redwood, cedar, and spruce to achieve effective copper penetration.

This application claims priority to U.S. Provisional Application Ser. No. 61/008,557 that was filed on Dec. 21, 2007, which is hereby incorporated by reference in its entirety.

### FIELD OF THE INVENTION

The present invention relates to a wood preservative composition and a process for treating wood with the composition for protecting wood from decay and insect attack. More particularly, the invention relates to a wood preservative composition comprising dispersed particles of a copper compound and a polydentate ligand. The composition can be used to treat difficult-to-treat wood species including hem fir, Douglas-fir, ponderosa pine, red pine, redwood, cedar, and spruce to achieve effective copper penetration.

### BACKGROUND OF THE INVENTION

Wood preservative compositions are well known for preserving wood and other cellulose-based materials, such as paper, particleboard, textiles, rope, etc., against organisms responsible for the destruction of wood, namely fungi and insects. Many conventional wood preserving compositions contain copper-amine or copper-ammonia complexes in which ethanolamine or ammonia are used as solubilizing agents and carriers. The disadvantage of using ammonia as a copper-solubilizing agent lies in the strong odor of ammonia. Additionally, copper-ammonia preservatives can affect the appearance of the treated wood giving surface residues and undesirable color. The disadvantages of using ethanolamine as a copper-solubilizing agent lie in that ethanolamine can cause high copper leaching from treated wood, and treated wood is also prone to mold growth.

As a result, scientists in the wood preservation field have researched and studied ways to eliminate the use of ammonia and amine. In the last few years, a number of patent applications have been filed relating to a use of micronized particles of copper compounds for preserving wood. U.S. Patent Publication Nos. 20040258767, 20050118280 and 20060288904, which are incorporated herein by reference, in their entireties, disclose the concept and method of preparing micronized copper particles for preserving wood with reduced copper leaching from treated wood. U.S. Patent Publication Nos. 20040258768, 20050252408 and 20060062926, which are incorporated herein by reference, in their entireties, also disclosed the use of micronized copper particles for treating wood. The copper particles disclosed in these patent applications can be prepared by one-step wet milling of commercially available copper compounds. Generally, the dispersed micronized copper formulations can be used to treat easy-to-treat sapwood species, such as southern yellow pine, radiate pine, and Brazilian pine, with effective copper penetration. However, when the same formulations are used to treat difficult-to-treat species, such as hem fir, Douglas-fir, red pine, ponderosa pine, spruce, cedar and redwood, insufficient copper penetration and deposition of copper particle residue on the surface of treated wood are observed. As a result, it still remains a challenge to treat difficult-to-treat species with effective copper penetration and satisfactory surface appearance.

Despite all the efforts to develop micronized copper formulation for treating wood, there has been an unmet need to produce micronized copper formulation for treat difficult-to-treat wood species with effective copper penetration and satisfactory surface appearance of treated wood. This need is solved by the subject matter disclosed herein.

### SUMMARY OF THE INVENTION

The present invention provides a wood preservative composition and a process for treating wood with the preservative composition for protecting wood from decay and insect attack. More particularly, the invention provides a wood preservative composition comprising dispersed fine particles of a copper compound and a polydentate ligand. The composition can be used to treat difficult-to-treat wood species including hem fir, Douglas-fir, ponderosa pine, red pine, redwood, cedar, and spruce using the conventional vacuum and/or pressure impregnation process.

Accordingly, in one embodiment, a wood preservative composition comprises dispersed particles of a copper compound and a polydentate ligand.

In another embodiment, a polymeric dispersant is used in the slurry of copper compounds for the milling process.

The present invention provides a wood preservative composition comprising a micronized inorganic biocide, a carrier and a polydentate ligand. In one embodiment, the inorganic biocide is at least one copper compound. In a preferred embodiment, the copper compound is copper hydroxide, copper oxide, copper carbonate, basic copper carbonate, copper oxychloride, copper 8-hydroxyquinolate, copper dimethyldithiocarbamate, copper omadine or copper borate. In a more preferred embodiment, the copper compound is copper carbonate.

The compositions of the present invention comprise one or more micronized inorganic biocides that have an average particle size of between 0.001 microns and 25 microns. In another embodiment, the micronized inorganic biocide has an average particle size of between 0.01 to 0.5 microns, between 0.05 to 0.3 microns or between 0.07 to 0.15 microns.

The compositions of the present invention comprise one or more micronized inorganic biocide particles, wherein at least 85% of the micronized inorganic biocide particles have an average particle size of less than 1.0 micron. In another embodiment, the compositions of the present invention comprise one or more micronized inorganic biocide particles, wherein at least 85% of the micronized inorganic biocide particles have an average particle size of less than 0.5 micron. In another embodiment, the compositions of the present invention comprise one or more micronized inorganic biocide particles, wherein at least 85% of the micronized inorganic biocide particles have an average particle size of less than 0.2 micron.

The compositions of the present invention comprise one or more polydentate ligands that include but are not limited to at least one carboxylic acid, aminopolycarboxylic acids, cuproine compounds, 2,2′-bipyridines, quinoxalines derivatives; or polyacrylic acids, or salts thereof, and the like. In a preferred embodiment, the polydentate ligand is at least one aminopolycarboxylic acid or salts thereof. The aminopolycarboxylic acids suitable for use with the present invention include, but are not limited to ethylenediaminetetraacetic acid (EDTA), N,N′-ethylenediamine disuccinic acid (EDDS), ethylenediamine-N,N,N′,N′-tetrapropionic acid, N,N′-ethylenediaminedipropionic acid, N,N-bis(carboxymethyl)anthranilic acid, 1,2-diaminocyclohexane-N,N,N′,N′-tetraacetic acid, diethylenetriaminepentaacetic acid, ethyleneglycol-bis(β-aminoethylether)-N,N′-tetraacetic acid, ethyletherdiaminetetraacetic acid, N-hydroxyethylethylenediaminetriacetic acid, 1-methylethylenediaminetetraacetic acid, or triethylenetetraaminehexaacetic acid, triethylenetetraaminehexaacetic acid, N-(hydroxyethyl)-ethylenediaminetriacetic acid, nitrilotriacetic acid, 2-hydroxyethyliminodiacetic acid or salts thereof. In a more preferred embodiment, the aminocarboxylic acid is one or more of EDTA, EDDS, or salts thereof.

The compositions of the present invention may further comprise one or more dispersants, one or more surfactants, or one or more thickening agents.

The composition of the present invention comprise a carrier. In one embodiment, the carrier is water or a liquid organic carrier. In a preferred embodiment, the carrier is water.

The compositions of the present invention may further comprise one or more organic biocides. In one embodiment, the organic biocides are micronized. In another embodiment, the organic biocides are solid. In yet another embodiment, the organic biocides are substantially insoluble in the carrier. In yet another embodiment, the organic biocides are soluble in the carrier. In one embodiment, the organic biocides include, but are not limited to, fungicides, moldicide, bactericides or insecticides. In another embodiment, the organic biocide is an azole fungicide. The azole fungicides suitable for use with the compositions of the present invention include, but are not limited to, tebuconazole, propiconazole, cyproconazole or 2-(2,4-difluorophenyl)-1-(1H-1,2,4-triazole-1-yl)-3-trimethylsilyl-2-propanol. In another embodiment, the organic biocide is a quaternary ammonium compounds. The quaternary ammonium compounds suitable for use with the compositions of the present invention include, but are not limited to didecyldimethylammonium chloride; didecyldimethylammonium carbonate/bicarbonate; alkyldimethylbenzylammonium chloride; alkyldimethylbenzylammonium carbonate/bicarbonate; didodecyldimethylammonium chloride; didodecyldimethylammonium carbonate/bicarbonate; didodecyldimethylammonium propionate; N,N-didecyl-N-methyl-poly(oxyethyl)ammonium propionate.

The compositions of the present invention may be formulated as a concentrate or as a treatment solution. As concentrates, the compositions of the present invention contain a copper compound in an amount between 1 and 90% copper or copper compound by weight, between 5 and 70% by weight or between 30 and 65% by weight. The treatment solutions of the present invention comprise compositions wherein the weight of the copper or copper compound is between 0.01% to 4.0% elemental copper, between 0.01 to 1.0% elemental copper, between 0.1% to 0.5% elemental copper, or between 0.02 to 0.3% elemental copper.

The present invention also provides a method for preserving a wood product comprising the steps of providing a wood product and contacting the wood product with the wood preservative composition of the present invention. The contacting step may include, but is not limited to, pressure treatment, spraying, dipping or brushing and the like. In a preferred method, the contacting step is pressure treatment.

The methods of treating wood of the present invention are suitable for the treatment of difficult-to-treat species such as hem fir, Douglas-fir, ponderosa pine, red pine, redwood, cedar, or spruce, and the like. The methods of the present invention may be used to treat refractory species. The methods of the present invention may also be used to treat a variety of cellulosic materials such as cardboard, paper, rope, and the like.

In one embodiment, the methods of treating wood of the present invention comprise the step of first contacting the wood product with the wood preservative composition. In another embodiment, the method of preparing the wood preservative composition comprises the step of mixing an inorganic biocide, a carrier and a polydentate ligand.

The present invention also provides method for preparing the wood preservative composition of the present invention comprising the step of mixing an inorganic biocide, a carrier and a polydentate ligand. In one embodiment, one or more of the components are mixed as a concentrate. In another embodiment, one or more of the components are diluted with a carrier before mixing with one or more of the other components.

The present invention also provides wood or cellulosic materials comprising the wood preservative compositions of the present invention. In one embodiment, the wood is a refractory species. In another embodiment, the wood is a difficult-to-treat species including, but not limited to, hem fir, Douglas-fir, ponderosa pine, red pine, redwood, cedar, or spruce. In one embodiment, the wood of the present invention comprises a composition of the present invention disbursed throughout the wood. In another embodiment, the micronized copper compound is present in the wood in amounts greater than 0.001 pcf. In another embodiment, the micronized copper or copper compound is present in the wood in amounts greater than 0.001 pcf elemental copper. In another embodiment, the micronized copper carbonate is present in the wood in amounts greater than 0.001 pcf elemental copper. In another embodiment, the micronized copper carbonate is present in amounts between 0.001 pcf and 0.5 pcf elemental copper. In yet another embodiment, the wood of the present invention is resistant to decay and insect attack.

### DETAILED DESCRIPTION OF THE INVENTION

Disclosed herein is a wood preservative composition comprising a copper compound and a polydentate ligand, and a process to treat difficult-to-treat wood species with the composition to protect wood from decay fungal and termite attack. The treated wood has effective copper penetration and satisfactory surface appearance.

In particular, the compositions of the present invention comprise a copper compound. Non-limiting examples of copper compounds include copper, copper carbonate, basic copper carbonate, copper hydroxide, cupric oxide, cuprous oxide, copper borate, copper oxychloride, copper 8-hydroxyquinolate, copper dimethyldithiocarbamate, copper omadine, or any other copper compounds that exhibit a relatively low solubility in water, for example a Ksp≦2.5×10-2. The copper and copper compounds of the present invention may also be solid.

The compositions may be prepared as fine copper particle dispersions by either one-step or two-step wet milling process. In the resulting product, 85, 90, 91, 92, 93, 94, 95, 96, 97, 98, 99, 99.1, 99.2, 99.3, 99.4, 99.5, 99.6, 99.7, 99.8, 99.9% or 100% of the milled particles are less than 1.0 micron. Preferably, 85, 90, 91, 92, 93, 94, 95, 96, 97, 98, 99, 99.1, 99.2, 99.3, 99.4, 99.5, 99.6, 99.7, 99.8, 99.9% or 100% of the milled particles are less than 0.5 microns, and more preferably, 85, 90, 91, 92, 93, 94, 95, 96, 97, 98, 99, 99.1, 99.2, 99.3, 99.4, 99.5, 99.6, 99.7, 99.8, 99.9% or 100% of the milled particles are less than 0.2 microns. The mean particle size in the dispersions can vary from 0.01 microns to about 0.5 microns, with a preferred range of 0.05 to 0.3 microns, and a more preferred mean particle size range of 0.07 to 0.15 microns.

The copper and copper compounds, can be mixed with water or any other carrier and a dispersant to make a pre-grinding slurry. The pre-grinding slurry is then transferred to the grinding chamber pre-filled with grinding media through a transfer pump. The grinding slurry may also comprise a dispersant. Suitable dispersants used in making the grinding slurry for the present invention may comprise a polymeric dispersant. We have surprisingly found that the polymeric dispersants can not only provide long-term stability of pigment dispersion particles, but also impart a high degree of stability during repetitive treatment processes. Generally, the weight average molecular weight of the polymeric dispersants varies from a few thousand to 100,000 or even more. Non-limiting examples of polymeric dispersant classes which can be used in the compositions of the present invention include acrylic copolymers, aqueous solution of copolymers with pigment affinity groups, polycarboxylate ether, modified polyacrylate or modified polyacrylate with groups of high pigment affinity, acrylic polymer emulsions, modified acrylic polymers, poly carboxylic acid polymers and their salts, modified poly carboxylic acid polymers and their salts, fatty acid modified polyester, aliphatic polyether or modified aliphatic polyether, solution of polycarboxylate ether, phosphate esters, phosphate ester modified polymers, polyglycol ethers or modified polyglycol ethers, polyetherphosphate, modified maleic anhydride/styrene copolymer, sodium polyacrylate, sodium polymethacrylate, lignin, modified lignin and the like; modified polyether or polyester with pigment affinic groups; fatty acid derivatives; urethane copolymer or modified urethane copolymer, polyetherphosphate, modified maleic anhydride/styrene copolymer, modified polycarboxylic acid or its derivatives, acrylic acid/maleic acid copolymer, polyvinyl pyrrolidone or modified polyvinyl pyrrolidone, sulfonates or sulfonate derivatives, polymeric alkoxylate or its derivatives, or modified lignin and the like. If desired, a stabilizer as is known in the art can be used. Other dispersants can be found in 2007 McCutcheon's Functional Materials (North American Edition).

We have found that polymeric dispersants, especially modified polycarboxylate ether, modified poly carboxylic acid polymers and their salts, solutions of polycarboxylate ethers; modified polyether or polyester with pigment affinic groups, perform well with copper compounds in providing wetting, dispersing, storage stabilization and stability during treatment process.

For a copper compound, the level of dispersant used in the composition is in the range of from about 0.1 to 180% based on the weight of the copper compound, with a preferred range of 1 to 80%, a more preferred range of 5 to 60%, and a most preferred range of 8 to 20%. If desired, a wetting agent can also be used in the preparation of the compositions of the present invention. The level of wetting agent is in the range of from about 0.1 to 180% of the weight of the biocide compounds, with a preferred range of 1 to 50%, a more preferred range of 5 to 10%.

The composition produced in the present invention can be a copper concentrate and the concentrate can be further diluted to a target level to treat wood. The total copper compound in the prepared concentrate is in the range of from 1 wt % to 90 wt % based on weight of composition, and preferably in the range of from 5 to 70 wt %, and more preferably in the range of from 30 to 65 wt %.

The compositions of the present invention also comprise a polydentate ligand. A polydentate ligand is an atom, ion or molecule that is attached to a central metal ion by bonds from two or more donor atoms. Polydentate ligands include bidentate, tridentate, quadridentate, pentadentate, and hexadentate ligands. In the present invention, a polydentate ligand may include a compound that is attached to the copper ion by bonds from two or more donor atoms. Non-limiting examples polydentate ligands that can be used in the present invention include carboxylic acids and their salts, such as aliphatic carboxylic acids, aromatic carboxylic acids, hydroxy carboxylic acids, mercapto carboxylic acids; amino acids and their salts; aminopolycarboxylic acids and their salts; cuproine compounds, such as 2,2′-biquonoline and its derivatives; 1,10-phenanthroline and its dervatives; 2,2′-bipyridine and its derivatives; quinoxaline derivatives; polyacrylic acids and its salts; and the like.

The preferred polydentate ligands are aminopolycarboxylic acids and their salts. The non-limiting examples are ethylenediaminetetraacetic acid and its salts; N,N′-ethylenediamine disuccinic acid and its salts; ethylenediamine-N,N,N′,N′-tetrapropionic acid and its salts; N,N′-ethylenediaminedipropionic acid and its salts; N,N-bis(carboxymethyl)anthranilic acid and its salts; 1,2-diaminocyclohexane-N,N,N′,N′-tetraacetic acid and its salts; diethylenetriaminepentaacetic acid and its salts; ethyleneglycol-bis(β-aminoethylether)-N,N′-tetraacetic acid and its salts; ethyletherdiaminetetraacetic acid and its salts; N-hydroxyethylethylenediaminetriacetic acid and its salts; 1-methylethylenediaminetetraacetic acid and its salts; triethylenetetraaminehexaacetic acid and its salts; N-(hydroxyethyl)-ethylenediaminetriacetic acid and its salts; nitrilotriacetic acid and its salts; 2-hydroxyethyliminodiacetic acid and its salts.

The most preferred compounds are the sodium or potassium or ammonium salts of ethylenediaminetetraacetic acid or N,N′-ethylenediamine disuccinic acid, such as mono-sodium, di-sodium, tri-sodium and tetra-sodium salts of ethylenediaminetetraacetic acid; mono-potassium, di-potassium, tri-potassium and tetra-potassium salts of ethylenediaminetetraacetic acid; mono-ammonium, di-ammonium, tri-ammonium and tetra-ammonium salts of ethylenediaminetetraacetic acid; mono-sodium, di-sodium, tri-sodium and tetra-sodium salts of N,N′-ethylenediamine disuccinic acid; and mono-potassium, di-potassium, tri-potassium and tetra-potassium salts of N,N′-ethylenediamine disuccinic acid; mono-ammonium, di-ammonium, tri-ammonium and tetra-ammonium salts of N,N′-ethylenediamine disuccinic acid.

The polydentate ligand can be added to the wood treating liquids directly, or be prepared as a liquid concentrate and then diluted along with fine particles of copper or copper compounds to make wood treating liquids. In the prepared, ready-for-use wood treating liquids, the copper concentrations in the liquids are generally in the range of 0.01% to 4.0% copper as elemental copper, for example. When the liquids are used to treat wood for above ground applications, the copper concentrations in the treating liquids are in the range of 0.01% to 1.0% copper as elemental copper, and the preferred range is between 0.1% to 0.5% copper and the more preferred range of 0.2% to 0.3% copper as elemental copper. When the liquids are used to treat wood for ground contact applications, the copper concentrations in the treating liquids are in the range of 0.3% to 4.0% copper as elemental copper, and the preferred range of 0.5% to 1.0% copper as elemental copper. When the polydentate ligand is added to the treating liquids, the molar ratio of polydentate ligand to copper is generally less than 0.01, 0.02, 0.03, 0.04, 0.05, 0.06, 0.07, 0.08, 0.090, 0.10, 0.2, 0.3, 0.4, 0.5, 0.6, 0.7, 0.8, 0.9 or 1.0, and the preferred molar ratio of the polydentate ligand to copper is less than 0.3.

When treating the difficult-to-treat wood species with fine particle dispersions of copper or copper compounds, an important aspect is the penetration of copper or copper compounds into the wood. We have surprisingly found that when a polydentate ligand is added to a particle copper formulation, the copper penetration in wood is significantly improved. When hem fir was treated with a dispersed copper formulation, only 35% of boring samples passed the copper penetration requirement set by AWPA Standard T1-07, Table 8.1.12. However, when a polydentate ligand, such as tetrasodium salt of ethylenediaminetetraacetic acid, was added to the same treating composition, 90% of the boring samples passed the copper penetration requirement set by the AWPA Standard. The penetration test was conducted in accordance with Section 14 in AWPA Standard A3-05 “Standard Method for Determining Penetration of Preservatives and Fire Retardants”.

The present invention also provides a method for preserving wood. In one embodiment, the method comprises the steps of treating wood with a composition (treating fluid) comprising a dispersion of water insoluble micronized copper compounds. In another embodiment, wood is treated with a composition comprising a dispersion of micronized copper and/or copper compounds and optionally organic biocides, wherein the organic biocides are soluble or present as water insoluble or solid micronized particles or as emulsion droplets.

The treating fluid may be applied to wood by dipping, soaking, spraying, brushing, or any other means well known in the art. In a preferred embodiment, vacuum and/or pressure techniques are used to impregnate the wood in accord with this invention including the standard processes, such as the “Empty-Cell” process, the “Modified Full-Cell” process and the “Full-Cell” process, and any other vacuum and/or pressure processes which are well known to those skilled in the art.

The standard processes are defined as described in the AWPA Glossary of Terms Used in Wood Protection. In the “Empty Cell” process, at atmospheric pressure (Lowry Process), or at higher air pressure of necessary intensity and duration (Rueping Process) there is injected, without a preliminary vacuum, an amount of preservative liquid in excess of the required final retention. This excess is then removed by a quick high vacuum. In the “Modified Full Cell” process, an initial vacuum lower than the final vacuum is used to enhance kick back of the treating liquid. The initial vacuum in this process is adjusted prior to the filling cycle to a level between atmospheric pressure and maximum final vacuum. For the “Full Cell Process”, an initial vacuum of not less than −77 kPa (22 inches of mercury at sea level) for not less than 30 minutes is applied before the treating vessel is filled with preservative liquid. Without breaking the vacuum the vessel is filled with the treating liquid and pressure is applied. After the pressure period the vessel is drained and a final vacuum may or may not be applied.

Other organic biocides can also be used with the fine particle dispersion of copper compounds. The organic biocides that can be used with copper compounds comprise triazoles, imidazoles, quaternary ammonium compounds, boron compounds, isothiazolone compounds.

Quaternary ammonium compounds that can be mixed with micronized copper formulations have the following structures:

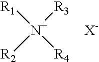

Where R1, R2, R3, and R4 are independently selected from alkyl or aryl groups and X⁻ selected from chloride, bromide, iodide, carbonate, bicarbonate, borate, carboxylate, hydroxide, sulfate, acetate, laurate, or any other anionic group.

Preferred quaternary ammonium compounds include didecyldimethylammonium chloride; didecyldimethylammonium carbonate/bicarbonate; alkyldimethylbenzylammonium chloride; alkyldimethylbenzylammonium carbonate/bicarbonate; didodecyldimethylammonium chloride; didodecyldimethylammonium carbonate/bicarbonate; didodecyldimethylammonium propionate; N,N-didecyl-N-methyl-poly(oxyethyl)ammonium propionate.

Fungicides which can be mixed with micronized copper formulations are:

### Aliphatic Nitrogen Fungicides

butylamine; cymoxanil; dodicin; dodine; guazatine; iminoctadine

### Amide Fungicides

carpropamid; chloraniformethan; cyazofamid; cyflufenamid; diclocymet; ethaboxam; fenoxanil; flumetover; furametpyr; prochloraz; quinazamid; silthiofam; triforine benalaxyl; benalaxyl-M; furalaxyl; metalaxyl; metalaxyl-M; pefurazoate; benzohydroxamic acid; tioxymid; trichlamide; zarilamid; zoxamide cyclafuramid; furmecyclox dichlofluanid; tolylfluanid benthiavalicarb; iprovalicarb benalaxyl; benalaxyl-M; boscalid; carboxin; fenhexamid; metalaxyl; metalaxyl-M metsulfovax; ofurace; oxadixyl; oxycarboxin; pyracarbolid; thifluzamide; tiadinil benodanil; flutolanil; mebenil; mepronil; salicylanilide; tecloftalam fenfuram; furalaxyl; furcarbanil; methfuroxam; flusulfamide

### Antibiotic Fungicides

aureofungin; blasticidin-S; cycloheximide; griseofulvin; kasugamycin; natamycin; polyoxins; polyoxorim; streptomycin; validamycin; azoxystrobin dimoxystrobin fluoxastrobin kresoxim-methyl metominostrobin orysastrobin picoxystrobin pyraclostrobin trifloxystrobin

### Aromatic Fungicides

biphenyl chlorodinitronaphthalene chloroneb chlorothalonil cresol dicloran hexachlorobenzene pentachlorophenol quintozene sodium pentachlorophenoxide tecnazene

### Benzimidazole Fungicides

benomyl carbendazim chlorfenazole cypendazole debacarb fuberidazole mecarbinzid rabenzazole thiabendazole

### Benzimidazole Precursor Fungicides

furophanate thiophanate thiophanate-methyl

### Benzothiazole Fungicides

bentaluron chlobenthiazone TCMTB

### Bridged Diphenyl Fungicides

bithionol dichlorophen diphenylamine

### Carbamate Fungicides

benthiavalicarb furophanate iprovalicarb propamocarb thiophanate thiophanate-methyl benomyl carbendazim cypendazole debacarb mecarbinzid diethofencarb

### Conazole Fungicides

climbazole clotrimazole imazalil oxpoconazole prochloraz triflumizole azaconazole bromuconazole cyproconazole diclobutrazol difenoconazole diniconazole diniconazole-M epoxiconazole etaconazole fenbuconazole fluquinconazole flusilazole flutriafol furconazole furconazole-cis hexaconazole imibenconazole ipconazole metconazole myclobutanil penconazole propiconazole prothioconazole quinconazole simeconazole tebuconazole tetraconazole triadimefon triadimenol triticonazole uniconazole uniconazole-P

### Dicarboximide Fungicides

famoxadone fluoroimide chlozolinate dichlozoline iprodione isovaledione myclozolin procymidone vinclozolin captafol captan ditalimfos folpet thiochlorfenphim

### Dinitrophenol Fungicides

binapacryl dinobuton dinocap dinocap-4 dinocap-6 dinocton dinopenton dinosulfon dinoterbon DNOC

### Dithiocarbamate Fungicides

azithiram carbamorph cufraneb cuprobam disulfuram ferbam metam nabam tecoram thiram ziram dazomet etem milneb mancopper mancozeb maneb metiram polycarbamate propineb zineb

### Imidazole Fungicides

cyazofamid fenamidone fenapanil glyodin iprodione isovaledione pefurazoate triazoxide

### Morpholine Fungicides

aldimorph benzamorf carbamorph dimethomorph dodemorph fenpropimorph flumorph tridemorph

### Organophosphorus Fungicides

ampropylfos ditalimfos edifenphos fosetyl hexylthiofos iprobenfos phosdiphen pyrazophos tolclofos-methyl triamiphos

### Oxathiin Fungicides

carboxin oxycarboxin

### Oxazole Fungicides

chlozolinate dichlozoline drazoxolon famoxadone hymexazol metazoxolon myclozolin oxadixyl vinclozolin

### Pyridine Fungicides

boscalid buthiobate dipyrithione fluazinam pyridinitril pyrifenox pyroxychlor pyroxyfur

### Pyrimidine Fungicides

bupirimate cyprodinil diflumetorim dimethirimol ethirimol fenarimol ferimzone mepanipyrim nuarimol pyrimethanil triarimol

### Pyrrole Fungicides

fenpiclonil fludioxonil fluoroimide

### Quinoline Fungicides

ethoxyquin halacrinate 8-hydroxyquinoline sulfate quinacetol quinoxyfen

### Quinone Fungicides

benquinox chloranil dichlone dithianon

### Quinoxaline Fungicides

chinomethionat chlorquinox thioquinox

### Thiazole Fungicides

ethaboxam etridiazole metsulfovax octhilinone thiabendazole thiadifluor thifluzamide

### Thiocarbamate Fungicides

methasulfocarb prothiocarb

### Thiophene Fungicides

ethaboxam silthiofam

### Triazine Fungicides

anilazine

### Triazole Fungicides

bitertanol fluotrimazole triazbutil

### Urea Fungicides

bentaluron pencycuron quinazamid

### Other Fungicides

acibenzolar acypetacs allyl alcohol benzalkonium chloride benzamacril bethoxazin carvone chloropicrin DBCP dehydroacetic acid diclomezine diethyl pyrocarbonate fenaminosulf fenitropan fenpropidin formaldehyde furfural hexachlorobutadiene iodomethane isoprothiolane methyl bromide methyl isothiocyanate metrafenone nitrostyrene nitrothal-isopropyl OCH 2 phenylphenol phthalide piperalin probenazole proquinazid pyroquilon sodium orthophenylphenoxide spiroxamine sultropen thicyofen tricyclazole

Preferred insecticides which can be mixed micronized copper formulations are:

### Antibiotic Insecticides

allosamidin thuringiensin spinosad abamectin doramectin emamectin eprinomectin ivermectin selamectin milbemectin milbemycin oxime moxidectin

### Botanical Insecticides

anabasine azadirachtin d-limonene nicotine pyrethrins cinerins cinerin I cinerin II jasmolin I jasmolin II pyrethrin I pyrethrin II quassia rotenone ryania sabadilla

### Carbamate Insecticides

bendiocarb carbaryl benfuracarb carbofuran carbosulfan decarbofuran furathiocarb dimetan dimetilan hyquincarb pirimicarb alanycarb aldicarb aldoxycarb butocarboxim butoxycarboxim methomyl nitrilacarb oxamyl tazimcarb thiocarboxime thiodicarb thiofanox allyxycarb aminocarb bufencarb butacarb carbanolate cloethocarb dicresyl dioxacarb EMPC ethiofencarb fenethacarb fenobucarb isoprocarb methiocarb metolcarb mexacarbate promacyl promecarb propoxur trimethacarb XMC xylylcarb

### Dinitrophenol Insecticides

dinex dinoprop dinosam DNOC cryolite sodium hexafluorosilicate sulfluramid

### Formamidine Insecticides

amitraz chlordimeform formetanate formparanate

### Fumigant Insecticides

acrylonitrile carbon disulfide carbon tetrachloride chloroform chloropicrin para-dichlorobenzene 1,2-dichloropropane ethyl formate ethylene dibromide ethylene dichloride ethylene oxide hydrogen cyanide iodomethane methyl bromide methylchloroform methylene chloride naphthalene phosphine sulfuryl fluoride tetrachloroethane

### Insect Growth Regulators

bistrifluoron buprofezin chlorfluazuron cyromazine diflubenzuron flucycloxuron flufenoxuron hexaflumuron lufenuron novaluron noviflumuron penfluoron teflubenzuron triflumuron epofenonane fenoxycarb hydroprene kinoprene methoprene pyriproxyfen triprene juvenile hormone I juvenile hormone II juvenile hormone III chromafenozide halofenozide methoxyfenozide tebufenozide α-ecdysone ecdysterone diofenolan precocene I precocene II precocene III dicyclanil

### Nereistoxin Analogue Insecticides

bensultap cartap thiocyclam thiosultap flonicamid clothianidin dinotefuran imidacloprid thiamethoxam nitenpyram nithiazine acetamiprid imidacloprid nitenpyram thiacloprid

organochlorine insecticides

bromo-DDT camphechlor DDT pp′-DDT ethyl-DDD HCH gamma-HCH lindane methoxychlor pentachlorophenol TDE aldrin bromocyclen chlorbicyclen chlordane chlordecone dieldrin dilor endosulfan endrin HEOD heptachlor HHDN isobenzan isodrin kelevan mirex

### Organophosphorus Insecticides

bromfenvinfos chlorfenvinphos crotoxyphos dichlorvos dicrotophos dimethylvinphos fospirate heptenophos methocrotophos mevinphos monocrotophos naled naftalofos phosphamidon propaphos schradan TEPP tetrachlorvinphos dioxabenzofos fosmethilan phenthoate acethion amiton cadusafos chlorethoxyfos chlormephos demephion demephion-O demephion-S demeton demeton-O demeton-S demeton-methyl demeton-O-methyl demeton-S-methyl demeton-S-methylsulphon disulfoton ethion ethoprophos IPSP isothioate malathion methacrifos oxydemeton-methyl oxydeprofos oxydisulfoton phorate sulfotep terbufos thiometon amidithion cyanthoate dimethoate ethoate-methyl formothion mecarbam omethoate prothoate sophamide vamidothion chlorphoxim phoxim phoxim-methyl azamethiphos coumaphos coumithoate dioxathion endothion menazon morphothion phosalone pyraclofos pyridaphenthion quinothion dithicrofos thicrofos azinphos-ethyl azinphos-methyl dialifos phosmet isoxathion zolaprofos chlorprazophos pyrazophos chlorpyrifos chlorpyrifos-methyl butathiofos diazinon etrimfos lirimfos pirimiphos-ethyl pirimiphos-methyl primidophos pyrimitate tebupirimfos quinalphos quinalphos-methyl athidathion lythidathion methidathion prothidathion isazofos triazophos azothoate bromophos bromophos-ethyl carbophenothion chlorthiophos cyanophos cythioate dicapthon dichlofenthion etaphos famphur fenchlorphos fenitrothion fensulfothion fenthion fenthion-ethyl heterophos jodfenphos mesulfenfos parathion parathion-methyl phenkapton phosnichlor profenofos prothiofos sulprofos temephos trichlormetaphos-3 trifenofos butonate trichlorfon mecarphon fonofos trichloronat cyanofenphos EPN leptophos crufomate fenamiphos fosthietan mephosfolan phosfolan pirimetaphos acephate isocarbophos isofenphos methamidophos propetamphos dimefox mazidox mipafox

### Oxadiazine Insecticides

indoxacarb

### Phthalimide Insecticides

dialifos phosmet tetramethrin

### Pyrazole Insecticides

acetoprole ethiprole fipronil tebufenpyrad tolfenpyrad vaniliprole

### Pyrethroid Insecticides

acrinathrin allethrin bioallethrin barthrin bifenthrin bioethanomethrin cyclethrin cycloprothrin cyfluthrin beta-cyfluthrin cyhalothrin gamma-cyhalothrin lambdacyhalothrin cypermethrin alpha-cypermethrin beta-cypermethrin theta-cypermethrin zeta-cypermethrin cyphenothrin deltamethrin dimefluthrin dimethrin empenthrin fenfluthrin fenpirithrin fenpropathrin fenvalerate esfenvalerate flucythrinate fluvalinate tau-fluvalinate furethrin imiprothrin metofluthrin permethrin biopermethrin transpermethrin phenothrin prallethrin profluthrin pyresmethrin resmethrin bioresmethrin cismethrin tefluthrin terallethrin tetramethrin tralomethrin transfluthrin etofenprox flufenprox halfenprox protrifenbute silafluofen

### Pyrimidinamine Insecticides

flufenerim pyrimidifen

### Pyrrole Insecticides

chlorfenapyr

### Tetronic Acid Insecticides

spiromesifen

### Thiourea Insecticides

diafenthiuron

### Urea Insecticides

flucofuron sulcofuron

### Other Insecticides

closantel crotamiton EXD fenazaflor fenoxacrim hydramethylnon isoprothiolane malonoben metoxadiazone nifluridide pyridaben pyridalyl rafoxanide triarathene triazamate

Preferred bactericides include, bronopol cresol dichlorophen dipyrithione dodicin fenaminosulf formaldehyde hydrargaphen 8-hydroxyquinoline sulfate kasugamycin nitrapyrin octhilinone oxolinic acid oxytetracycline probenazole streptomycin tecloftalam or thiomersal.

Preferred triazole compounds and imidazole compounds for use with the copper and copper compound dispersions prepared in the present invention are tebuconazole; cyproconazole; propiconazole; hexaconazole, 1-[[2-(2,4-dichlorophenyl)-1,3-dioxolan-2-yl]methyl]-1H-1,2,4-triazole; cis-trans-3-chloro-4-[4-methyl-2-(1H-1,2,4-triazol-1-ylmethyl)-1,3-dioxolan-2-yl]phenyl 4-chlorophenyl ether; (RS)-2-(4-fluorophenyl)-1-(1H-1,2,4-triazol-1-yl)-3-(trimethylsilyl)propan-2-ol; or 2-(2,4-difluorophenyl)-1-(1H-1,2,4-triazole-1-yl)-3-trimethylsilyl-2-propanol.

Preferred isothiazolone compounds for use with the copper and copper compound dispersions prepared in the present invention are methylisothiazolinone; chloromethylisothiazolinone; 4,5-Dichloro-2-n-octyl-3(2H)-isothiazolone; or 1,2-benzisothiazolin-3-one; 2-octyl-3-isothiazolone.

Additional preferred organic biocides comprise iodopropynyl butylcarbamate (IPBC); chlorothalonil; 2-(thiocyanatomethylthio) benzothiazole; alkoxylated diamines and carbendazim; fludioxonil, thiabendazole, difenoconazole, azoxystrobin, or lambda cyhalothrin.

Most organic biocides are water insoluble. Prior to use, the organic biocides can be either dispersed and milled into fine particles or prepared as an emulsified concentrate, and then combined with a copper or copper dispersion for treating wood.

The following examples are provided to further describe certain embodiments of the disclosure but are in no way limiting to the scope of disclosure.

### EXAMPLES

### Example 1

20 pieces of the commercially used incised hem fir lumbers with a nominal size of 2″×6″×8′ were used in the current study. Prior to the pressure impregnation, each piece was cut into two 4-foot sections. As a result, 2 sets of hem fir samples with matched pieces were generated, and each set was used in the following treatment.

I A—Treating the Hem Fir with Fine Copper Particle Dispersion

A wood preservative treating liquid containing 0.35% CuO and 0.35% didecyldimethylammonium carbonate/bicarbonate (Quat) was prepared by mixing water with a Quat concentrate and a concentrate of copper carbonate particle dispersion with mean particle size less than 0.25 microns. The treating liquid was used to treat one set of hem fir samples with a modified full cell treating schedule including 30 min initial vacuum at 27-inch Hg, 2 hour pressure at 190 psi, and 20 minutes final vacuum at 27-inch Hg. After treatment, the borings were taken for measuring copper penetration. The penetration test was conducted in accordance with Section 14 in AWPA Standard A3-05 “Standard Method for Determining Penetration of Preservatives and Fire Retardants”. The result indicated that only 35% boring samples passed the copper penetration requirement set by AWPA Standard T1-07, Table 8.1.12.

I B—Treating the Hem Fir with Fine Copper Particle Dispersion plus a Polydentate Ligand

A wood preservative treating liquid containing 0.35% CuO, 0.35% didecyldimethylammonium carbonate/bicarbonate (Quat), and 0.2% tetra-sodium ethylenediaminetetraacetate was prepared by mixing water with a Quat concentrate, a tetra-sodium ethylenediaminetetraacetate, and a concentrate of copper carbonate particle dispersion with mean particle size less than 0.25 microns. The treating liquid was used to treat the other set of hem fir samples with the same treating schedule as Example IA. After treatment, the borings were taken for measuring copper penetration. The penetration test was conducted in accordance with Section 14 in AWPA Standard A3-05 “Standard Method for Determining Penetration of Preservatives and Fire Retardants”. The result indicated that 90% boring samples passed the copper penetration requirement set by AWPA Standard T1-07, Table 8.1.12. A significant improvement on the copper penetration was observed.

### Example 2

20 pieces of the commercially used red pine lumbers with a nominal size of 2″×6″×8′ were used in the current study. Prior to the pressure impregnation, each piece was cut into two 4-foot sections. As a result, 2 sets of red pine samples with matched pieces were generated, and each set was used in the following treatment.

II A—Treating the Red Pine with Fine Copper Particle Dispersion

A wood preservative treating liquid containing 0.20% CuO and 0.20% didecyldimethylammonium carbonate/bicarbonate (Quat) was prepared by mixing water with a Quat concentrate and a concentrate of copper carbonate particle dispersion with mean particle size less than 0.10 microns. The treating liquid was used to treat one set of red pine samples with a modified full cell treating schedule including 30 min initial vacuum at 27-inch Hg, 1.5 hour pressure at 190 psi, and 40 minutes final vacuum at 27-inch Hg. After treatment, the borings were taken for measuring copper penetration. The penetration test was conducted in accordance with Section 14 in AWPA Standard A3-05 “Standard Method for Determining Penetration of Preservatives and Fire Retardants”. The result indicated that only 30% boring samples passed the copper penetration requirement set by AWPA Standard T1-07, Table 8.1.12.

II B—Treating Red Pine with Fine Copper Particle Dispersion plus a Polydentate Ligand

A wood preservative treating liquid containing 0.20% CuO, 0.20% didecyldimethylammonium carbonate/bicarbonate (Quat), and 0.20% tetra-sodium ethylenediaminetetraacetate was prepared by mixing water with a Quat concentrate, a tetra-sodium ethylenediaminetetraacetate, and a concentrate of copper carbonate particle dispersion with mean particle size less than 0.10 microns. The treating liquid was used to treat the other set of red pine samples with the same treating schedule as Example IIA. After treatment, the borings were taken for measuring copper penetration. The penetration test was conducted in accordance with Section 14 in AWPA Standard A3-05 “Standard Method for Determining Penetration of Preservatives and Fire Retardants”. The result indicated that 65% boring samples passed the copper penetration requirement set by AWPA Standard T1-07, Table 8.1.12. A significant improvement on the copper penetration was observed.

### Example 3

20 pieces of the commercially used red pine lumbers with a nominal size of 2″×6″×8′ were used in the current study. Prior to the pressure impregnation, each piece was cut into two 4-foot sections. As a result, 2 sets of red pine samples with matched pieces were generated, and each set was used in the following treatment.

III A—Treating the Red Pine with a Conventional Copper Formulation Containing Amine Copper Quaternary (ACQ-D)

A wood preservative treating solution containing 0.27% CuO and 0.13% didecyldimethylammonium carbonate/bicarbonate (Quat) was prepared by mixing water with a Quat concentrate and a Cu-amine solution concentrate. The treating solution was used to treat one set of red pine samples with a modified full cell treating schedule including 30 min initial vacuum at 27-inch Hg, 1.5 hour pressure at 120 psi, and 20 minutes final vacuum at 27-inch Hg. After treatment, the borings were taken for measuring copper penetration. The penetration test was conducted in accordance with Section 14 in AWPA Standard A3-05 “Standard Method for Determining Penetration of Preservatives and Fire Retardants”. The result indicated that only 80% boring samples passed the copper penetration requirement set by AWPA Standard T1-07, Table 8.1.12.

III B—Treating Red Pine with Fine Copper Particle Dispersion plus a Polydentate Ligand

A wood preservative treating liquid containing 0.26% CuO, 0.13% didecyldimethylammonium carbonate/bicarbonate (Quat), and 0.20% tetra-sodium ethylenediaminetetraacetate was prepared by mixing water with a Quat concentrate, a tetra-sodium ethylenediaminetetraacetate, and a concentrate of copper carbonate particle dispersion with mean particle size less than 0.10 microns. The treating liquid was used to treat the other set of red pine samples with the same treating schedule as Example IIIA. After treatment, the borings were taken for measuring copper penetration. The penetration test was conducted in accordance with Section 14 in AWPA Standard A3-05 “Standard Method for Determining Penetration of Preservatives and Fire Retardants”. The result indicated that 80% boring samples passed the copper penetration requirement set by AWPA Standard T1-07, Table 8.1.12.

This study indicated that the present composition disclosed in this application demonstrated similar copper penetration property as the conventional solution copper formulation (ACQ-D).

We claim:

1. A wood preservative composition comprising a micronized copper compound and a polydentate ligand.

2. The composition of claim 1, wherein the copper compound is copper hydroxide, copper oxide, copper carbonate, basic copper carbonate, copper oxychloride, copper 8-hydroxyquinolate, copper dimethyldithiocarbamate, copper omadine or copper borate.

3. The composition of claim 2, wherein the copper compound is copper carbonate or copper hydroxide.

4. The composition of claim 1, wherein the micronized copper compound has an average particle size of between 0.001 microns and 25 microns.

5. The composition of claim 4, wherein the micronized copper compound has an average particle size of between 0.01 to 0.5 microns.

6. The composition of claim 5, wherein the micronized copper compound has an average particle size of between 0.05 to 0.3 microns.

7. The composition of claim 6, wherein the micronized copper compound has an average particle size between 0.07 to 0.15 microns.

8. The composition of claim 1, wherein at least 85% of the micronized copper compound particles have an average particle size of less than 1.0 micron.

9. The composition of claim 8, wherein at least 85% of the micronized copper compound particles have an average particle size of less than 0.5 micron.

10. The composition of claim 9, wherein at least 85% of the micronized copper compound particles have an average particle size of less than 0.2 micron.

11. The composition of claim 1, wherein the polydentate ligand is at least one carboxylic acid, aminopolycarboxylic acids, cuproine compounds, 2,2′-bipyridines, quinoxalines derivatives; or polyacrylic acids, or salts thereof.

12. The composition of claim 1, wherein the polydentate ligand is at least one aminopolycarboxylic acid or salts thereof.

13. The composition of claim 1, wherein the at least one aminopolycarboxylic acid is a ethylenediaminetetraacetic acid, N,N′-ethylenediamine disuccinic acid, ethylenediamine-N,N,N′,N′-tetrapropionic acid, N,N′-ethylenediaminedipropionic acid, N,N-bis(carboxymethyl)anthranilic acid, 1,2-diaminocyclohexane-N,N,N′,N′-tetraacetic acid, diethylenetriaminepentaacetic acid, ethyleneglycol-bis(β-aminoethylether)-N,N′-tetraacetic acid, ethyletherdiaminetetraacetic acid, N-hydroxyethylethylenediaminetriacetic acid, 1-methylethylenediaminetetraacetic acid, or triethylenetetraaminehexaacetic acid or salts thereof.

14. The composition of claim 1, further comprising one or more dispersants.

15. The composition of claim 1, further comprising one or more organic biocides.

16. The composition of claim 1, wherein the organic biocide is an azole fungicide.

17. The composition of claim 16, wherein the azole fungicide is tebuconazole, propiconazole, cyproconazole or 2-(2,4-difluorophenyl)-1-(1H-1,2,4-triazole-1-yl)-3-trimethylsilyl-2-propanol.

18. The composition of claim 1, wherein the weight of the copper compound is between 1 and 90% by weight.

19. The composition of claim 18, wherein the weight of the copper compound is between 5 and 70% by weight.

20. The composition of claim 19, wherein the weight of the copper compound is between 30 and 65% by weight.

21. The composition of claim 1, wherein the weight of the copper compound is between 0.01% to 4.0% elemental copper.

22. The composition of claim 21, wherein the weight of the copper compound is between 0.01 to 1.0% elemental copper.

23. The composition of claim 22, wherein the weight of the copper compound is between 0.1% to 0.5% elemental copper.

24. The composition of claim 23, wherein the weight of the copper compound is between 0.2% to 0.3% elemental copper.

25. A method for preserving a wood product comprising the steps of providing a wood product and contacting the wood product with the wood preservative composition of claim 21.

26. The method of claim 25, wherein the contacting of the wood product with the composition is by pressure treatment, spraying, dipping or brushing.

27. The method of claim 26, wherein the treatment of wood is carried out by pressure treatment.

28. The method of claim 25, wherein the wood product is hem fir, Douglas-fir, ponderosa pine, red pine, redwood, cedar, or spruce.

29. A method for preserving a wood product comprising the steps of providing a wood product and contacting the wood product with a first composition comprising a micronized copper compound and a second composition comprising a polydentate ligand.

30. The method of claim 29, wherein the wood product is first contacted with the first composition.

31. A method of preparing the wood preservative composition of claim 1, comprising the step of mixing an inorganic biocide and a polydentate ligand.

32. A method of preparing the wood preservative composition of claim 21, comprising the step of mixing the copper compound and a polydentate ligand.

33. Wood comprising the wood preservative composition of claim 1.

34. Wood comprising the wood preservative composition of claim 21.

35. The wood of claim 33, wherein the wood is hem fir, Douglas-fir, ponderosa pine, red pine, redwood, cedar, or spruce.

36. The wood of claim 34, wherein the wood is hem fir, Douglas-fir, ponderosa pine, red pine, redwood, cedar, or spruce.

37. The wood of claim 33, wherein the micronized copper carbonate is present in amounts greater than 0.001 pcf elemental copper.

38. The wood of claim 34, wherein the micronized copper carbonate is present in amounts greater than 0.001 pcf elemental copper.

39. The wood of claim 35, wherein the micronized copper carbonate is present in amounts greater than 0.001 pcf elemental copper.

40. The wood of claim 36, wherein the micronized copper carbonate is present in amounts greater than 0.001 pcf elemental copper.

41. The wood of claim 33, wherein the micronized copper carbonate is present in amounts between 0.001 pcf and 0.5 pcf elemental copper.

42. The wood of claim 33, wherein the wood is resistant to decay and insect attack.

43. The composition of claim 15, wherein the organic biocide is a quaternary ammonium compound.

44. The composition of claim 43 wherein the quaternary ammonium compound is didecyldimethylammonium chloride; didecyldimethylammonium carbonate/bicarbonate; alkyldimethylbenzylammonium chloride; alkyldimethylbenzylammonium carbonate/bicarbonate; didodecyldimethylammonium chloride; didodecyldimethylammonium carbonate/bicarbonate; didodecyldimethylammonium propionate; N,N-didecyl-N-methyl-poly(oxyethyl)ammonium propionate
